(19) United States
(12) Patent Application Publication
(10) Pub. No.: US 2014/0274243 A1
(43) Pub. Date: Sep. 18, 2014

(54) TAILORING EDUCATIONAL LEARNING ENVIRONMENTS

(71) Applicants: MARIO LOPEZ, LITTLETON, CO (US); ALVARO ARIAS, CENTENNIAL, CO (US); JEFFREY FARMER, FORT COLLINS, CO (US)

(72) Inventors: MARIO LOPEZ, LITTLETON, CO (US); ALVARO ARIAS, CENTENNIAL, CO (US); JEFFREY FARMER, FORT COLLINS, CO (US)

(73) Assignee: COLORADO SEMINARY, DENVER, CO (US)

(21) Appl. No.: 13/833,592

(22) Filed: Mar. 15, 2013

(51) Int. Cl. A63F 13/40

(52) U.S. Cl. CPC A63F 13/10
USPC 463/9

(57) ABSTRACT

A method of tailoring an educational learning environment to a particular student may include receiving a selection of an educational game type from a plurality of educational game types and determining a learning activity. The method may also include determining a difficulty level for the learning activity and accessing a parameter set based on the learning activity and the difficulty level. The method may additionally include accessing, based on the parameter set, a set of functional instructions and a plurality of graphic objects. The method may further include creating an educational game based on the set of functional instructions, the plurality of graphic objects, the educational game type, the learning activity, and the difficulty level.

### STATEMENT AS TO RIGHTS TO INVENTIONS MADE UNDER FEDERALLY SPONSORED RESEARCH AND DEVELOPMENT

This invention was made with government support under contract HHS-2009-ACF-OHS-YD-00251 awarded by the Administration for Children & Families—Office of Head Start. The government has certain rights in the invention.

### BACKGROUND

Games may fulfill a number of important educational purposes. Some games may be explicitly designed with educational purposes, while others may have incidental or secondary educational value. All types of games may be used in an educational environment. Educational games are games that are designed to teach students about certain subjects, expand concepts, reinforce development, understand a historical event or culture, or assist them in learning a skill as they play.

Games can be particularly effective for younger children. When compared to traditional classroom instruction, games offer a learning method that may be more engaging and stimulating to younger students. This may be particularly true of computer-based educational games. Modern classrooms are often equipped with computers and display devices that allow students to learn in a computerized environment. However, the needs of younger students are widely varied and rapidly changing. A particular educational game may only be useful for a small segment of a student's learning career as they progress rapidly through subject matter and difficulty levels. Furthermore, the cost of developing and keeping computer-based educational games up to date may be prohibitive given the tight budgets of most school systems. Therefore, improvements in the art may be necessary.

### BRIEF SUMMARY

In one embodiment, a method of tailoring an educational learning environment to a particular student may be presented. The method may include receiving a selection of an educational game type from a plurality of educational game types and determining a learning activity. The method may also include determining a difficulty level for the learning activity and accessing a parameter set based on the learning activity and the difficulty level. The method may additionally include accessing, based on the parameter set, a set of functional instructions and a plurality of graphic objects. The method may further include creating an educational game based on the set of functional instructions, the plurality of graphic objects, the educational game type, the learning activity, and the difficulty level.

In another embodiment, a computer-readable memory may be presented. The computer-readable medium may have stored thereon a sequence of instructions which, when executed by one or more processors, causes the one or more processors to tailor an educational learning environment to a particular student by receiving a selection of an educational game type from a plurality of educational game types and determining a learning activity. The sequence of instructions may also cause the processor(s) to operate by determining a difficulty level for the learning activity and accessing a parameter set based on the learning activity and the difficulty level. The sequence of instructions may additionally cause the processor(s) to operate by accessing, based on the parameter set, a set of functional instructions and a plurality of graphic objects. The sequence of instructions may further cause the processor(s) to operate by creating an educational game based on the set of functional instructions, the plurality of graphic objects, the educational game type, the learning activity, and the difficulty level.

In yet another embodiment, a system may be presented. The system may include one or more processors and a memory communicatively coupled with and readable by the one or more processors and having stored therein a sequence of instructions which, when executed by the one or more processors, cause the one or more processors to tailor an educational learning environment to a particular student by by receiving a selection of an educational game type from a plurality of educational game types and determining a learning activity. The sequence of instructions may also cause the processor(s) to operate by determining a difficulty level for the learning activity and accessing a parameter set based on the learning activity and the difficulty level. The sequence of instructions may additionally cause the processor(s) to operate by accessing, based on the parameter set, a set of functional instructions and a plurality of graphic objects. The sequence of instructions may further cause the processor(s) to operate by creating an educational game based on the set of functional instructions, the plurality of graphic objects, the educational game type, the learning activity, and the difficulty level.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a block diagram illustrating components of an exemplary operating environment in which various embodiments of the present invention may be implemented.

FIG. 2 illustrates a block diagram illustrating an exemplary computer system in which embodiments of the present invention may be implemented.

FIG. 3A illustrates an educational game template, according to one embodiment.

FIG. 3B illustrates another educational game template, according to one embodiment.

FIG. 4 illustrates a block diagram of a process flow for creating an educational game type, according to one embodiment.

FIG. 5 illustrates a plurality of educational game types, according to one embodiment.

FIG. 6 illustrates a block diagram of a process flow for determining a learning activity, according to one embodiment.

FIG. 7 illustrates a block diagram of a process flow for determining a difficulty level, according to one embodiment.

FIG. 8 illustrates a block diagram of a process flow for creating an educational game, according to one embodiment.

FIG. 9A illustrates an educational game, according to one embodiment.

FIG. 9B illustrates another educational game, according to one embodiment.

FIG. 10 illustrates a flowchart of a method for creating a plurality of educational game types for a particular student to select, according to one embodiment.

FIG. 11 illustrates a flowchart of a method for tailoring an educational learning environment to a particular student, according to one embodiment.

FIG. 12 illustrates a block diagram of an educational gaming system, according to one embodiment.

FIG. 13 illustrates a block diagram depicting the flexibility of a game system architecture, according to one embodiment.

FIG. 14 illustrates a block diagram of adaptable learning trajectories, according to one embodiment.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to, portable or fixed storage devices, optical storage devices, wireless channels, and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a machine-readable medium. A processor(s) may perform the necessary tasks.

Described herein are embodiments for tailoring an educational learning environment to a particular student or group of students. A set of educational game templates may provide the basic functionality for an educational game. However, the details and implementation of the educational game can be filled in using a set of parameters. The set of parameters may load the details of the educational game into an educational game template. These details may include graphic objects and functionalities that are based on a selected learning activity and difficulty level. The learning activity and difficulty level can be selected using a randomizer, teacher inputs, student inputs, educational standards, and/or game constraints, depending on the particular embodiment.

Educational gaming systems are subject to an iterative and cyclic design process that takes place in educational research. Children can be exposed to an educational gaming system, and their interactions and performance can be tracked. Based on what is learned from the observation and tracking, education professionals will typically need to alter the educational gaming system to meet identified needs. Therefore, according to one embodiment, a novel game system architecture can be designed to facilitate and accommodate this educational research paradigm. Thus, embodiments may include a flexible software architecture that is extensible, customizable, and structured so that many important changes can be made without requiring programmer involvement. Changes that do require programmer involvement can be minimized.

Many good software systems quickly become obsolete because of the high cost of maintenance and evolution. These costs often account for more than 90% of the total cost of the software lifetime costs. Once a software product is implemented, users and researchers often find errors that need to be fixed. Alternatively, new features are often identified as desirable that require substantial redesign and additional code. Software that supports educational research may require more changes than regular commercial software, and the cost of maintaining educational software can easily make the product stagnant as these costs mount over time. These expenses can be avoided by recognizing up front the types of changes that may be required in a system and by designing a system that can easily accommodate these changes.

As a result, the educational gaming system described herein includes embodiments that may use software-based games to teach and evaluate children using basic learning concepts. Educational games may comprise an activity that a child will find entertaining, yet challenging in a way that can test and evaluate a child's knowledge in a particular area. Educational games can be designed such that a child can intuitively maneuver through the games' mechanics, while at the same time learning or testing their knowledge in a new concept. For example, a child may intuitively be able to navigate a graphical object around obstacles on a display screen in a way that teaches the child basic spatial recognition concepts or tests their skill in this area.

The basic game design can be stored in the educational game template that is decoupled from a set of data that determine how the game is implemented. Educational standards, learning activities, teacher inputs, student histories, game template restrictions, student inputs, and/or the like can be checked when the game template is accessed, and a set of parameters can be used to load different functionalities and game art that are tailored for each interaction with a particular student. Therefore, a single game template may result in (what appears to a child as) several different games, depending on the art and functionality that are loaded according to the set of parameters.

The educational gaming system comprised of educational game templates, parameters, student histories, teacher inputs, educational standards, etc. will be described in detail throughout the remainder of this disclosure. Included are computer-implemented methods for constructing an educational game from these various components. Additionally, a system and a computer-readable medium product are presented that can be implemented using a computer system.

According to one embodiment, the methods, systems, and products described herein can be implemented in a variety of different computer systems. FIG. 1 is a block diagram illustrating components of an exemplary operating environment in which various embodiments of the present invention may be implemented. The system 100 can include one or more user computers 105, 110, which may be used to operate a client, whether a dedicated application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, a tablet computer, a smart phone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may be any type of network familiar to those skilled in the art that can support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO, etc.

The system may also include one or more server computers 120, 125, 130, which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers, which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130 and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, which is adapted to store, update, and retrieve data in response to SQL-formatted commands.

FIG. 2 illustrates an exemplary computer system 200 in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor, and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices, such as network input/output devices, may be employed. Software of computer system 200 may include code 250 for implementing embodiments of the present invention as described herein.

The following methods may be implemented by a computer system, such as computer system 200 in FIG. 2. Each step of these methods may be done automatically by the computer system and/or may be provided as inputs and/or outputs to a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a Web service, and/or the like. Likewise, outputs may be provided to a user, to another computer system as a data stream, saved in a memory location, sent over a network, provided to a web service, and/or the like. In short, each step of the methods described herein may be performed by a computer system and may involve any number of inputs, outputs, and/or requests to and from the computer system, which may or may not involve a user. Therefore, it will be understood in light of this disclosure that each step and each method described herein may be altered to include an input and output to and from a user or may be done automatically by a computer system.

Turning now to a description of how an educational game can be generated using a computer system similar to the computer system described above, FIG. 3A illustrates an educational game template 300a, according to one embodiment. The educational game template 300a may also be referred to as a parameterized game template. This allows the resulting game to take advantage of new animation and gaming technologies as they arise. The educational game template 300a represents an abstract software framework that is designed to implement a variety of learning activities, and that can be easily reconfigured to display different concrete environments. Using this model, the administrator of an educational gaming system can easily reconfigure the external appearance of the game to run with different themes and agents. Not only does this add variety to the game experience, but it supports learning by presenting the children with changing contexts of the same concepts. This enhances the development of the sort of abstraction skills that are so central to topics such as mathematics, logical reasoning, and spatial recognition.

For instance, an educational game template may support a counting activity, while the underlying theme may change from fish swimming in the ocean, to birds flying above the forest, to various kinds of animals in a livestock show, or even to abstract geometric shapes such as triangles or polygons. The physical attributes of the elements, such as color, size, texture, and/or the like, as well as their behavior, such as speed of motion, flocking patterns, sounds, reactions, and/or the like, can be easily changed according to the set of parameters.

Specifically, educational game template 300a represents a basic gaming mechanic of elements arranged spatially in a grid 302. The grid 302 can be resized and reordered to have a varying number of rows, columns, and/or topologies based on the set of parameters. For example, the set of parameters might specify seven columns and five rows in a rectangular topology, as shown by grid 302. Alternatively, the grid could be a rearranged in a circular topology, or any other geometric topology, —with varying numbers of divisions defining the grid elements.

In this particular embodiment, the grid 302 includes a control element 304 and a target element 308. In one implementation, the child may be required to move the control element 304 around the grid 302, which may contain obstacles, to reach the target element 308. Depending on the functionality that is later implemented by the educational game template 300a, the control element 304 may be moved by clicking within the grid 302. In another embodiment, directional controls 306 can be provided, and the control element 304 may be moved by clicking on one or more of the directional controls 306.

The control element 304, the target element 308, the grid 302, and the directional controls 306 may be considered placeholders for graphic objects. In other words, after the set of parameters is accessed, actual graphical art objects can replace the placeholders. The graphical objects may include icons, animations, photographs, and/or the like, and will be described in greater detail hereinafter. Additionally, the background of the educational game template 300a may be replaced by graphical scenery.

The educational game template 300a need not require that each of the placeholders be used in each implementation. For example, in one implementation, the control element 304 may be eliminated, and the child may simply click on the appropriate target element 308. In another implementation, one or more of the directional controls 306 may be eliminated. For example, for beginning levels, the vertical controls may be eliminated, such as the child only needs to move the control element 304 in the horizontal direction. One particular educational game that is derived from the educational game template 300a is discussed below in relation to FIG. 9A.

According to one embodiment, the educational game template 300a need only represent the skeletal constructs used to implement a number of different games. Therefore, by changing the art associated with the placeholders and the functionality that defines how the various placeholders interact, the educational game template 300a can be used to create numerous different educational games. These educational games can appear to be different games to the child and may be used to teach and evaluate any number of different learning activities.

FIG. 3B illustrates another educational game template 300b, according to one embodiment. Instead of using a grid and directional movements, educational game template 300b can use shapes. The shape area 310 may be implemented to include various arrangements of different elementary shapes. The shape area 310 may also include a graphical object in the background, such as a picture of an animal. Various shapes in the shape area 310 can be used to cover the background picture. The child may then be instructed to select certain types, sizes, and/or colors of shapes in order to reveal the hidden picture.

The shape placeholders 312 may include one or more of the shapes that are presented in the shape area 310. In one implementation, the child may be instructed to drag a shape from the shape area 310 to a corresponding shape represented by the shape placeholders 312. For example, a circle may conceal a portion of the picture background representing the head of an animal. When selecting the circle, the shape placeholders 312 may dynamically present a circle, rectangle, and the triangle. The child may then drag the circle from the shape area 310 to the circle in the shape placeholders 312. In this embodiment, at least the shape area 310 and the shape placeholders 312 may represent placeholders that can be filled in according to the set of parameters. The ways in which these placeholders interact can be defined by the functionality loaded according to the set of parameters.

It will be understood that educational game template 300a and educational game template 300b represent only two examples of educational game templates that can be used to generate a plurality of educational games. Various embodiments can be implemented using an unlimited number of different types of educational game templates. However, it would be impossible to describe each of the possible educational game template designs within this disclosure. Therefore, only a few examples are presented for brevity. After reading this disclosure, and in light of the principles taught herein, one having ordinary skill in the art would be able to design many different educational game templates contemplated by the various embodiments of this invention.

In some embodiments, an educational game can be created directly from an educational game template. However, in one embodiment, an intermediate step can be performed. Specifically, a plurality of educational game types can first be derived from the educational game templates. An educational game type may comprise an intermediate stage that is in between the template and the fully implemented game. A certain level of functionality and certain number of graphical objects may be associated and implemented in the game template such that a student can get a general feel for the theme and activity involved in a game.

Generating a set of educational game types may offer a number of benefits. According to one embodiment, the educational game types may be displayed to a student. For example, the student may be able to choose from several different educational game types that have been derived from the same educational game template, such as educational game template 300a. Depending on the art that is loaded into the control element and target element placeholders, the student could choose games entitled, “help froggy catch the fly,” or “help the mouse get the cheese,” etc.

FIG. 4 illustrates a block diagram 400 of a process flow for creating an educational game type, according to one embodiment. A plurality of game templates 402 may be accessed, according to a set of parameters (not shown). In one embodiment, the set of parameters can include a representation of the data, activities, standards, and arrangement of game elements, along with their dependencies. The parameter set may be stored in a standard format such as XML. In one embodiment, the parameter set may include field/value combinations that can include tags and descriptions. The parameter set may be stored in a format that exposes the functionality and generality of this approach in creating an educational software project. Consequently, the parameter set may be stored in a format that can be read by number of different software products, such as Microsoft Excel, SynapticMash, standard database software, etc.

In the embodiment of FIG. 4, educational game template 408 within the plurality of game templates 402 may be used to determine specific fields that are accessed within the parameter set. Next, a plurality of graphical objects 404 may be accessed according to the fields that were previously accessed within the parameters set. For example, the control element and the target element within educational game template 408 may reference two parameters in the set of parameters that instruct the system to load graphic object 410 representing a frog and graphic object 412 representing a fly. Graphic object 410 and graphic object 412 may be incorporated into educational game template 408, along with other graphic objects in the plurality of graphic objects 404, such as the arrow elements, to create an educational game type entitled “help froggy catch the fly.”

By incorporating a number of graphic objects into a particular educational game template, enough information may be presented to a student such that the student can determine whether or not the game would be fun or interesting to play. The result of this combination is the educational game type 406. It will be understood that the plurality of graphic objects 404 displayed in FIG. 4 is merely exemplary and that any number, type, size, style, and/or pattern may be used for a graphic object. For example, a graphic object may include clipart, photographs, JPGs, and/or the like.

Furthermore, the number of graphic objects that are incorporated into a particular educational game template may be determined by making a determination as to how much information a student would need to make an intelligent choice as to which game to play. This determination may be made using statistical analysis, trial and error, or may be set by the teacher.

In one embodiment, it may be advantageous to use a parameter set because the parameter set may be easily edited and/or configured by nonprogrammers, including teachers. For example, if a teacher felt that using frog and fly icons was not engaging enough for their students, the teacher could select graphic objects that would be more engaging. The teacher could then simply edit an XML or Excel file implementing the parameter set to load different graphic objects.

It will be understood that many different educational game types may be created from a single educational game template. Although only one example is shown here for brevity, many other educational game types would be readily recognized by one having ordinary skill in the art in light of this disclosure. For example, shapes or pictures may be loaded into educational game template 414 to create a second educational game type entitled, “select the correct shape.”

FIG. 5 illustrates a plurality of educational game types 500, according to one embodiment. Educational game type 502, educational game type 504, and educational game type 506 may have been derived from the same educational game template. However, educational game type 508 may have been derived from a second educational game template, such as educational game template 414 in FIG. 4. This is but a small set of the educational game types that may be derived in light of this disclosure.

In one embodiment, graphical representations of the plurality of educational game types 500 may be displayed on a computer display device to a student, such as a tablet or notebook computer. The student could click on one of the visual representations as shown in FIG. 5 to select the type of game that he/she would like to play. In one embodiment, the plurality of educational game types 500 may be displayed on a webpage. When a student clicks on one of the plurality of educational game types 500, the webpage may navigate to another webpage that implements the selected educational game type to create a specific game using the process that will be described in more detail below.

FIG. 6 illustrates a block diagram 600 of a process flow for determining a learning activity, according to one embodiment. As used herein, the term “learning activity” need not refer to an actual game, but rather to a type of activity used to teach a certain skill to a certain level of proficiency. Each learning activity can be supported by several educational games, and each game may be implemented by many different learning activities.

Various environments can use different types of learning activities. For example, a “spatial sense” learning activity can be used to teach and test a student's skill in navigation and directional reasoning. An “identify color” learning activity can be used to teach and test a student's skill in identifying and differentiating between different colors. An “identify numeral” learning activity can teach and test a student's skill in identifying and differentiating between textual numbers. An “identify 5 frame” learning activity can teach and test a student's skill in identifying and differentiating between different numbers of dots within a 5-grid graphic. An “identify shape” learning activity can teach and test a student's skill in identifying, differentiating, and maneuvering different shapes. An “identify finger” learning activity can teach and test a student's skill in identifying and differentiating between different representations of numbers on cartoon hand. An “identify mixed” learning activity can combine selected elements one or more of the other “identify” learning activities.

A learning activity can be represented by a subset of the set of parameters. For example, a learning activity can be defined by a set of graphic objects and functionalities that are implemented within an educational game type according to the subset of the set of parameters. For example, for the “identify finger” learning activity, the subset of the set of parameters may instruct the educational gaming system to load graphic objects representing cartoon figure representations of numbers. The subset of the set of parameters may also instruct the educational gaming system to load a functionality that instructs and allows a student to take certain actions within the educational game type to choose a correct cartoon finger representation.

In order to determine a learning activity, a number of different inputs may be considered. These inputs may include a randomizer 602, a teacher input 604, a student history 606, education standards 608, and game constraints 610. In one embodiment, the student may be presented with a number of educational game types, such as those shown in FIG. 5. When the student clicks on one of the educational game types, the educational gaming system may determine a learning activity based on one or more of these inputs.

The teacher input 604 can be used to select a learning activity from a plurality of available learning activities 612. For example, a teacher may select a subset of the plurality of available learning activities 612 that the teacher deems appropriate for their particular classroom. Alternatively or additionally, the teacher may assign certain learning activities to individual students based on their individual progress. In one embodiment, the teacher input 604 may override any of the other inputs, thereby giving the teacher a maximum amount of control over the students' learning experience.

The student input 605 may also be considered. For example, after a student selects an educational game type, the student may also be presented with a list of learning activities. The student may then select a learning activity from the list for implementation in an educational game. Other inputs, such as the teacher input 604, may be used to limit the student's available choices.

The student history 606 may also be considered. In one embodiment, a student's performance in each of the available learning activities 612 may be tracked by the educational gaming system. The student history 606 can include scores, achievements, number of attempts, and/or the like for each student. In one embodiment, the student history 606 can influence the choice of learning activity by presenting or emphasizing learning activities that are determined, by analyzing the student history 606, to be most beneficial to the student. For example, if a student has repeatedly failed the “match shape” learning activity, this learning activity along with other similar learning activities could be presented to the student. In another embodiment, the repeatedly failed learning activity may be set aside so as not to discourage the student.

Educational standards 608 may also be encoded within the educational gaming system and may be considered in determining a learning activity. Educational standards 608 might include local and/or national standards that define curricula or required test scores. Educational standards 608 can be encoded into a format that may be easily read by the educational gaming system, such as XML, CSV, a relational database table, and/or the like. The educational standards 608 may determine which learning activities should be emphasized in the selection process. The educational standards 608 may also be used to determine passing and failing scores for the student history, which may determine when a student may move on from one learning activity to the next.

Game constraints 610 may also influence the determination of a learning activity. For example, some educational game types and/or educational game templates may not be compatible with certain learning activities and/or vice versa. For example, if a student chooses the educational game type entitled, “help froggy catch the fly,” then it is possible that the “match shape” learning activity may not be compatible with this particular educational game type. In this way, constraints of the game types/templates may influence the determination of a learning activity.

Additionally, a randomizer 602 may be used. In one embodiment, one or more of the inputs listed above may be used to determine a set of possible learning activities. The final selected learning activity may be chosen based on input from the randomizer 602. In one embodiment, the possible learning activities selected by the other inputs may be weighted such that it is more probable that one learning activity is selected as opposed to another. In other words, a set of possible learning activities may first be determined using inputs such as the teacher input 604, the student input 605, the student history 606, the education standards 608, and/or the game constraints 610. Each of the set of possible learning activities can be assigned a score based on these inputs, and the score can influence a probabilistic weight that is used by the randomizer 602 to select a final learning activity.

It will be understood that any combination of these inputs listed in FIG. 6 may be used to determine a learning activity. Furthermore, other inputs may be used that are not explicitly shown. For example, a user preference file may be stored and used as an input. Also, inputs may be provided from a district or state regulatory agency. Other types of inputs will be readily recognized in light of this disclosure by one having ordinary skill in the art. In the example of FIG. 6, one or more of the inputs shown may be used to select from the learning activities 612 a final learning activity 614 representing a “spatial sense” learning activity.

FIG. 7 illustrates a block diagram 700 of a process flow for determining a difficulty level, according to one embodiment. Each learning activity may be available in a number of different learning activity levels. These levels may define the difficulty of the learning activity. The difficulty may relate to a range of numerals that a student is expected to master, a group of letters/sounds the student should know, and/or the like. For example, the “identify numeral” learning activity may have a level “1” that expects the student to learn the numerals 1 to 3. Subsequent levels may increase this range. For example, level “3” may expect a student to learn numerals 1 to 5, and so forth.

The process for determining a learning activity level may be very similar to the process for determining the learning activity 702 itself. For example, each of the inputs previously discussed, namely the teacher input 604, the student input 605, the student history 606, the education standards 608, and/or the game constraints 610, could also influence the selection of the learning activity level. Furthermore, the learning activity 702 may also influence the learning activity level.

As one example, the learning activity 702 corresponding to the “spatial sense” learning activity may include levels 2 through 5. These levels may be relative to other learning activities, and therefore it may be implied that the first “spatial sense” learning activity at level 2 is perceived to be more difficult than other learning activities that start at level 1.

The teacher input 604 can be used to set both a baseline and/or a ceiling for the learning activity levels. For example, the teacher could stipulate that all students should start at least at level 3 for any learning activity. Alternatively, the teacher could stipulate that students should not progress beyond level 6. Also, a teacher could also stipulate that all activities at level 1 should be completed before any learning activity of a higher level may be attempted.

In one embodiment, the student history 606 may play a key role in determining the learning activity level. If the student has passed a certain number of learning activities at level 1, then the educational gaming system may determine that the student should continue with learning activities at higher levels, thus skipping lower levels. For example a student may be determined to be proficient at all activities at level 1 by scoring highly on a few activities at level 1.

In one embodiment, as learning activities are randomly and/or deterministically selected, the educational gaming system can consult the student history 606 to keep track of the appropriate learning activity level for each learning activity. This allows a student to jump between learning activities without losing their progress made in each.

Similar to how they were used in determining a learning activity, the education standards 608 and the game constraints 610 may also influence the learning activity level. In the particular embodiment illustrated by FIG. 7, the one or more inputs discussed above are used to select a learning activity level from the possible learning activity levels 704 for the learning activity 702. In this example, level 3 is selected, and the final learning activity may be defined as “spatial sense 3.”

After determining the learning activity and the learning activity level, these can be used to access the set of parameters and create a final educational game. FIG. 8 illustrates a block diagram 800 of a process flow for creating an educational game, according to one embodiment. Generally, the set parameters 804 can be accessed to load graphics objects 806 along with functionalities 808 that will govern the way the educational game 810 is displayed and played.

In one embodiment, the educational gaming system can analyze the learning activity with its associated level and then access one or more parameters in the set of parameters 804. For example, a parameter entitled “Spatial_Sense_Control_Element” could have as a value a URL pointing to a graphic object. Note that, in this particular embodiment, the control object need not depend on the learning activity level. In another example, a parameter entitled “Spatial_Sense_{—}3_Target_Element” could have as a value a URL pointing to a graphic object representing a particular shape targeted to level 3 students.

As used herein, the terms “parameter set” or “set of parameters” may refer to any collection parameters, no matter how they are stored. In one embodiment, the set of parameters 804 may be stored in a single database or XML file. In another embodiment, the set of parameters 804 may be stored in many different files. This embodiment may make it easier to edit and update the implementations of educational games.

In addition to using the learning activity and the learning activity level, additional inputs may be used to access the set parameters 804. For example, the teacher input 604, the student history 606, and the education standards 608 may all be used to access the set of parameters 804. Other inputs discussed herein may also be used, even though they are not explicitly depicted in FIG. 8. Accessing and using the set of parameters 804 in this step may be very similar to how they were used in relation to FIG. 4. In other words, graphical placeholders in the educational game types may be replaced with graphical objects, just as they were in the educational game templates described earlier. The only difference would be that here a complete educational game is implemented and ready to play, whereas previously only an educational game type was created to give the student enough information to choose the game.

In addition to loading graphic objects 806, the parameters may be used to access a functionality 808. The functionality 808 may be comprised of code that describes how the various graphic objects 806 interact with each other and with the student. For example, a functionality may comprise code that describes how a particular graphic object will behave when a student clicks on an arrow icon on the screen. In another example, a functionality may comprise code that determines how a student's score is affected by certain inputs and/or behaviors. It will be understood that these functionalities could govern an unlimited number and type of behaviors. While they cannot all be described here for brevity, they will be clear to one having ordinary skill in the art in light of this disclosure.

A functionality may comprise code that is dynamically executed by the educational gaming system. Alternatively or additionally, a functionality may already be coded into an educational game type or educational game template, and the parameter may simply be used to determine which branch of the pre-existing code is executed.

In one embodiment, the end result of this operation is to access a set of functional instructions and a plurality of graphic objects based on the parameter set and, from these, to create an educational game 810 based on the set of functional instructions, the plurality of graphic objects, the educational game type, the learning activity, and the difficulty level. FIG. 9A illustrates an educational game 900a, according to one embodiment. Educational game 900a may be derived from educational game template 300a from FIG. 3A.

In this particular embodiment, control element 304 has been replaced with graphic object 904 representing a frog. The target element 308 has been replaced by graphic object 906 representing a fly. A title banner 902 has been added to provide context and instructions for the student to play the educational game 900a. Also, background elements 912 representing lily pads have been added to help solidify the theme of the game for the student. Additional graphic objects 910 have been added to either serve as scenery or obstacles in the game, depending on implementation.

Note that in this implementation, the directional elements 306 have been replaced by arrows 908. Also note that the directional elements 306 corresponding to vertical movements have been removed. Placeholders in the educational game template 300a may be omitted from the actual implementation of the educational game 900a according to the difficulty level and/or other inputs.

As the student successfully moves the frog to the fly using the arrows 908, the educational game 900a can store the student's results. As the student completes the educational game 900a, the educational gaming system can present a new educational game using the same educational game type from which educational game 900a was derived. In other words, the theme of “helping froggy catch the fly” can be used to teach and test spatial skills, as well as number recognition, color recognition, letter recognition, and/or the like. In one embodiment, the educational gaming system may present educational games implementing different learning activities in succession in order to keep the student's interest and prevent the student from repeating the same learning activity over and over. When learning activities are repeated, the difficulty level can be increased. In another embodiment, the educational gaming system may automatically switch to an educational game derived from a different educational game type.

FIG. 9B illustrates another educational game 900b, according to one embodiment. Educational game 900b may be derived from educational game template 300b in FIG. 3B. In this implementation, the shape area 310 has been filled in with the graphic object 920 representing an animal. Graphic object 920 has been obscured by graphic objects 922 comprising a number of elementary shapes. Shape elements 312 on the right side of the display have been replaced by graphic object 920 representing a rectangle, graphic object 922 representing a circle, and graphic object 924 representing a triangle. As in educational game 900a, a title banner 930 has been added to provide context and instructions for the student.

In this particular implementation, a student may drag shapes appearing in the shape area to a corresponding shape in the area on the right side of the display. When all the shapes have been correctly dragged to the right side of the display, graphic object 920 will be revealed, showing the student the animal.

It will be understood that educational game 900a and educational game 900b are merely exemplary, and not meant to be limiting. Other embodiments can implement other learning activities and use other educational game templates as discussed elsewhere herein.

FIG. 10 illustrates a flowchart 1000 of a method for creating a plurality of educational game types for a particular student to select, according to one embodiment. The method may include accessing a plurality of educational game templates (1002). The method may also include accessing the parameter set (1004). In one embodiment, the parameter set may be accessed based on the plurality of educational game templates. The method may additionally include accessing the plurality of graphic objects (1006). In one embodiment, the plurality of graphic objects may be accessed based on the parameter set. The method may further include creating the plurality of educational game types (1008). In one embodiment, the plurality of educational game types may be based on the plurality of educational game templates and the plurality of graphic objects. The method may also include causing representations of the plurality of educational game types to be displayed to the particular student (1010). In one embodiment, each of the plurality of educational game templates may comprise a placeholder for a graphic object.

FIG. 11 illustrates a flowchart 1100 of a method for tailoring an educational learning environment to a particular student, according to one embodiment. The method may include receiving a selection of an educational game type from a plurality of educational game types (1102). In one embodiment, the selection is received from an interface that displays the plurality of educational game types that were caused to be displayed in the method of FIG. 10. The method may also include determining a learning activity (1104). The method may additionally include determining a difficulty level for the learning activity (1106). The method may further include accessing a parameter set (1108). In one embodiment, accessing the parameter set may be based on the learning activity and the difficulty level. The method may additionally include accessing a set of functional instructions and a plurality of graphic objects (1110). The method may further include creating an educational game (1112). In one embodiment, the educational game may be based on the set of functional instructions, the plurality of graphic objects, the educational game type, the learning activity, and/or the difficulty level.

In one embodiment, the method may optionally include generating a report for the particular student based on a student history and a performance of the particular student associated with the educational game. The format and/or content of the report may correspond to a template chosen by the teacher. Alternatively or additionally, the format and/or content of the report may correspond to educational standards. For example, certain federal education standards may require teachers to report student progress in a certain format against the established standards. One embodiment may use the educational standards to derive an acceptable report. The format of the report may also determine what statistics are stored and how they are presented.

In one embodiment, the learning activity can be determined based on an input from a teacher. In another embodiment, the learning activity can be determined based on a student history of the particular student. In yet another embodiment, the learning activity can be determined based on a set of educational standards. In yet another embodiment, the learning activity can be determined based on a random input.

In one embodiment, the difficulty level for the learning activity may be based on a student history of the particular student. In another embodiment, the difficulty level may be based on an input from a teacher.

In one embodiment, the activity level may comprise identifying colors. In another embodiment, the learning activity may comprise navigating objects to a destination on a display. In yet another embodiment, the learning activity may comprise identifying representations of numerical values.

It should be appreciated that the specific steps illustrated in FIGS. 10-11 provide particular methods of generating an educational game according to various embodiments of the present invention. Other sequences of steps may also be performed according to alternative embodiments. For example, alternative embodiments of the present invention may perform the steps outlined above in a different order. Moreover, the individual steps illustrated in FIGS. 10-11 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 12 illustrates a block diagram 1200 of an educational gaming system, according to one embodiment. The educational gaming system may include a data store 1216 that includes one or more databases, memories, and/or the like. The data store 1216 may be implemented using any of the memory devices described previously herein. In one embodiment, the data store 1216 includes a parameter database 1218, a student history database 1220, a template database 1222, an educational standards database 1224, and/or a graphical object database 1228. In another embodiment, the data store 1216 may include a set of functionalities or code that is used to generate educational games.

The educational gaming system may also include a processing system 1202 that may be implemented using one or more processors, FPGAs, lookup tables, microcontrollers, or any other similar piece of processing hardware. Processing system 1202 may include an input interface configured to receive teacher inputs 1212. The teacher inputs 1212 may be stored in a file, or may be received directly from a human input device. Additionally, the processing system 1202 may include an interface configured to receive student inputs 1214. Student inputs 1214 may be used to both generate educational game and to play the educational game.

The processing system 1202 may be communicatively coupled to the data store 1216 and may be able to read and/or write to individual databases within the data store 1216. The processing system 1202 may include a randomizer 1204, a game generation engine 1206, and/or a game type generation engine 1208. Each of the modules within the processing system 1202 may be implemented using the same piece of hardware/software or may be implemented by specialized hardware/software. The processing system 1202 may include an output interface 1210 configured to cause graphic representations of educational game types and educational games to be displayed on display device.

In one embodiment, the various modules and systems in FIG. 12 may reside on separate computer systems. Alternatively, multiple modules may be combined on the same or similar computer systems. In addition, some modules may be combined together into a single module performing the functions of both individual modules. Similarly, a single module may be split into multiple modules. It will be understood, in light of this disclosure, that any arrangement of the modules, as well as any implementation in both software and hardware, may be used by various embodiments. It will also be understood that a block diagram 1200 of FIG. 12 is merely exemplary and other configurations of hardware/software may be used to implement an educational gaming system.

FIG. 13 illustrates a block diagram 1300 depicting the flexibility of a game system architecture, according to one embodiment. Block diagram 1300 emphasizes how the game system architecture described herein can be flexible, extensible, highly customizable, and structured so that many important changes can be made without computer programmer involvement. Different components of the software can be decoupled from each other to support several types of learning environments.

In one embodiment, the educational game 1316 may be considered the entry point to the software when being accessed by a student. When a student logs in, the educational game system can use information from the various components to generate an educational game that presents learning activities at the proper level of difficulty and that are customized to enhance the student experience. As described above, these various components may include a student profile 1302, teacher inputs 1304, educational standards 1306, learning trajectories 1308, graphics and art 1310, language 1312, and/or music 1314. As the student passes or fails the educational game 1316, the student profile may change, and this information may be used to present new activities for the next educational game.

Additionally, the educational gaming system can support several different types of reports 1318 that can be produced using information from the various components. In one embodiment, the reports 1318 may be generated using the student profile 1302, the teacher input 1304, the educational standards 1306, and/or the learning trajectories 1308.

The educational game system architecture presented herein offers advantages in a number of different situations. Merely by way of example, the educational game 1316 can be modified to target students from various language backgrounds. This can be accomplished by simply changing the language 1312 library, the graphics/art 1310 library, and/or the music 1314 library. The result may be an educational game 1316 with the same learning activities and learning trajectories that can be provided to students from various cultural backgrounds. For example, the language, graphics, and/or music can be customized to support students from a Native American culture.

In another example, the educational game system may support students with learning disabilities. These students may need more practice and more experiences with each level of the learning activities. This may require passing different thresholds, which may be modified using the student profile 1302 and/or the learning trajectories 1308 component.

In yet another example, different types of research may suggest that various learning theories and learning trajectories may be beneficial to different types of students. These theories may direct the learning activities to be presented in different orders. Additionally, these theories may ask the educational game system to emphasize some activities more than others in the random selection of possible activities. These types of changes can be made to support various learning theories by modifying the learning trajectories 1308 component.

In yet another example, learning trajectories may be static (but changeable) or dynamic. Thus, based on educational research theory, the educational game system can choose the best learning trajectory that supports the profile of the student. For example, in mathematics, a more geometrically-inclined student may benefit if more of the activities have a geographic element emphasizing shapes and/or spatial relationships rather than numbers or numerals.

FIG. 14 illustrates a block diagram 1400 of adaptable learning trajectories, according to one embodiment. These learning trajectories may be decoupled from other components of the educational software system in order to easily implement changes. Block diagram 1400 illustrates three different stages, namely Stage 1, Stage 2, and Stage 3. The progression between the various stages illustrates the type of changes that can be implemented during a standard educational research cycle. Each circle may represent specific learning activities at a predetermined level. The directed graphs connecting the circles may represent the learning trajectories that are used by the software to present the learning activities.

For example, Stage 1 can represent a learning trajectory for a particular student in their progression through various levels of the educational game system, A1-A8. If the student profile associated with the particular student indicates that the student has not passed A1 or A2, then the educational game system need only present educational games associated with A1 or A2, which can be done randomly. If A1 is passed by the particular student, then the educational game system will be able to present the educational game associated with A3. The educational game system may only be able to present an educational game associated with A4 if both A1 and A2 have been passed. Similarly, the educational game system might only present A6 if A3 and A4 have been passed.

In one example, a research cycle may analyze student progress through the various levels A1-A8. After the research cycle, it may become apparent that level A3 may need A2 as a prerequisite. Stage 2 of block diagram 1400 may represent a new learning trajectory graph embodying this information. Here, A2 is connected to A3 to represent this new pre-requisite relationship. Note that only a computer representation of the graph in Stage 1 may need to be altered. This process may be simple enough that it can be done by a teacher, possibly without the aid of a computer programmer.

Similarly, it may also become apparent that the step between A4 and A6 is too large. In other words, the transition between A4 and A6 may require more student support. The Stage 3 graph above shows a new graph with A9 inserted between A4 and A6, and with the edge connecting A4 to A6 removed. Again, these changes need only be made to the learning trajectories components of the educational game system architecture. Some embodiments may not require changes to any other components of the architecture.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of tailoring an educational learning environment to a particular student, the method comprising:
receiving a selection of an educational game type from a plurality of educational game types;
determining a learning activity;
determining a difficulty level for the learning activity;
accessing a parameter set based on the learning activity and the difficulty level;
accessing, based on the parameter set, a set of functional instructions and a plurality of graphic objects;
creating an educational game based on the set of functional instructions, the plurality of graphic objects, the educational game type, the learning activity, and the difficulty level.

2. The method of claim 1, further comprising:
accessing a plurality of educational game templates;
accessing, based on the plurality of educational game templates, the parameter set;
accessing, based on the parameter set, the plurality of graphic objects;
creating the plurality of educational game types based on the plurality of educational game templates and the plurality of graphic objects;
causing representations of the plurality of educational game types to be displayed to the particular student.

3. The method of claim 2 wherein each of the plurality of educational game templates comprises a placeholder for a graphic object.

4. The method of claim 1, further comprising generating a report for the particular student based on a student history and a performance of the particular student associated with the educational game.

5. The method of claim 4 wherein the report for the particular student is further based on a performance of the particular student associated with a second educational game.

6. The method of claim 1 wherein determining a learning activity is based on an input from a teacher.

7. The method of claim 1 wherein determining a learning activity is based on a student history of the particular student.

8. The method of claim 1 wherein determining a learning activity is based on a set of educational standards.

9. The method of claim 1 wherein determining a learning activity is based on a random input.

10. The method of claim 1 wherein a difficulty level for the learning activity is based on an input from a teacher.

11. The method of claim 1 wherein a difficulty level for the learning activity is based on a student history of the particular student.

12. The method of claim 1 wherein a difficulty level for the learning activity is based on a set of educational standards.

13. The method of claim 1 wherein the learning activity comprises identifying colors.

14. The method of claim 1 wherein the learning activity comprises identifying representations of numerical values.

15. The method of claim 1 wherein the learning activity comprises navigating an object to a destination on a display.

16. A computer-readable memory having stored thereon a sequence of instructions which, when executed by one or more processors, causes the one or more processors to tailor an educational learning environment to a particular student by:
receiving a selection of an educational game type from a plurality of educational game types;
determining a learning activity;
determining a difficulty level for the learning activity;
accessing a parameter set based on the learning activity and the difficulty level;
accessing, based on the parameter set, a set of functional instructions and a plurality of graphic objects;
creating an educational game based on the set of functional instructions, the plurality of graphic objects, the educational game type, the learning activity, and the difficulty level.

17. The computer-readable memory according to claim 16, wherein the instructions further cause the one or more processors to tailor an educational learning environment to a particular student by:
accessing a plurality of educational game templates;
accessing, based on the plurality of educational game templates, the parameter set;
accessing, based on the parameter set, the plurality of graphic objects;
creating the plurality of educational game types based on the plurality of educational game templates and the plurality of graphic objects;
causing representations of the plurality of educational game types to be displayed to the particular student.

18. The computer-readable memory according to claim 16, wherein determining a learning activity is based on a set of educational standards.

19. A system comprising:
one or more processors; and
a memory communicatively coupled with and readable by the one or more processors and having stored therein a sequence of instructions which, when executed by the one or more processors, cause the one or more processors to tailor an educational learning environment to a particular student by:
receiving a selection of an educational game type from a plurality of educational game types;
determining a learning activity;
determining a difficulty level for the learning activity;
accessing a parameter set based on the learning activity and the difficulty level;
accessing, based on the parameter set, a set of functional instructions and a plurality of graphic objects;
creating an educational game based on the set of functional instructions, the plurality of graphic objects, the educational game type, the learning activity, and the difficulty level.

20. The system of claim 19 wherein the instructions further cause the one or more processors to tailor an educational learning environment to a particular student by:
accessing a plurality of educational game templates;
accessing, based on the plurality of educational game templates, the parameter set;
accessing, based on the parameter set, the plurality of graphic objects;
creating the plurality of educational game types based on the plurality of educational game templates and the plurality of graphic objects;
causing representations of the plurality of educational game types to be displayed to the particular student.
